(19) United States
(12) Patent Application Publication
(10) Pub. No.: US 2017/0227202 A1
(43) Pub. Date: Aug. 10, 2017

(54) Illuminable Key Chain

(71) Applicants: Jiadong Ma, Darien, IL (US); Robert Carter Russell, Northfield, IL (US)

(72) Inventors: Jiadong Ma, Darien, IL (US); Robert Carter Russell, Northfield, IL (US)

(21) Appl. No.: 15/018,777

(22) Filed: Feb. 8, 2016

(51) Int. Cl. F21V 23/04; F21V 33/00; F21L 4/00; A44B 15/00

(52) U.S. Cl. CPC F21V 23/0414; A44B 15/00; F21V 33/0004; F21L 4/00

(57) ABSTRACT

An illuminable key chain comprises a housing, a receiving formation on the housing configured to receive a key ring, a band having a first end and a second end, the first and second ends coupled to the housing, and a light source disposed within the housing and configured to project light into or onto the band when the light source is supplied with power.

### FIELD OF THE DISCLOSURE

The present description relates generally to key chains, including novelty and promotional key chains.

### BACKGROUND OF RELATED ART

Key chains are generally known. Such known key chains may be generally customized for novelty, promotional, or other purposes by printing a name, logo, slogan, etc. on an exterior surface of the key chain.

### BRIEF DESCRIPTION OF THE DRAWINGS

FIG. 1 is an isometric view of an exemplary illuminable key chain.

FIG. 2 is a front view of the exemplary illuminable key chain of FIG. 1.

FIG. 3 is a back view of the exemplary illuminable key chain of FIG. 1.

FIG. 4 is a right-side view of the exemplary illuminable key chain of FIG. 1.

FIG. 5 is a left-side view of the exemplary illuminable key chain of FIG. 1.

FIG. 6 is a top view of the exemplary illuminable key chain of FIG. 1.

FIG. 7 is a bottom view of the exemplary illuminable key chain of FIG. 1.

FIG. 8 is an exploded view of the exemplary illuminable key chain of FIG. 1.

FIG. 9 is an isometric view of a housing portion of the exemplary illuminable key chain of FIG. 1.

### DETAILED DESCRIPTION

Known novelty and promotional key chains can be improved upon by providing illumination to the novelty or promotional aspect of the key chain. Additionally or alternatively, known novelty and promotional writing implements can be improved upon by providing one or more eye-catching symbols (e.g., logos or designs) or words (e.g., names or slogans) on an illuminable aspect of the key chain.

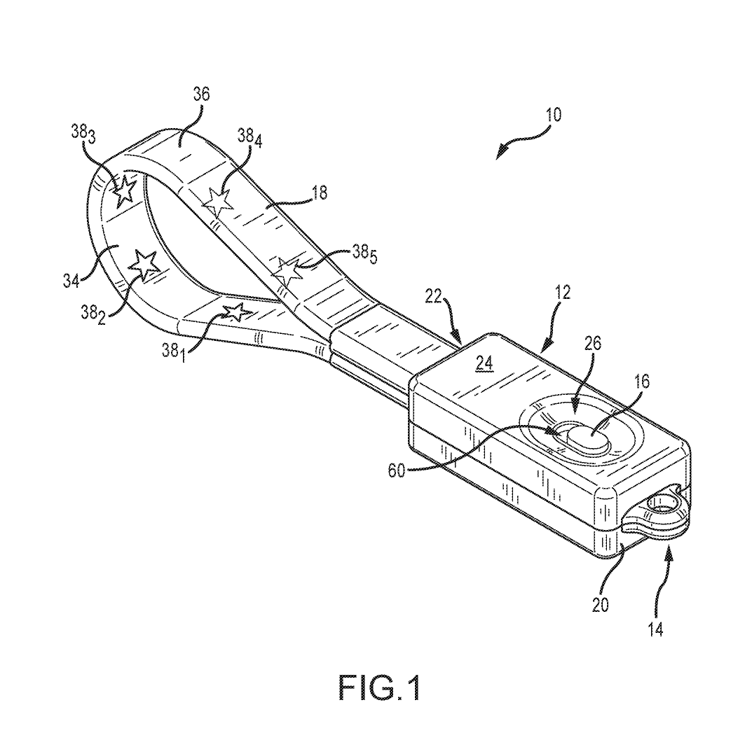

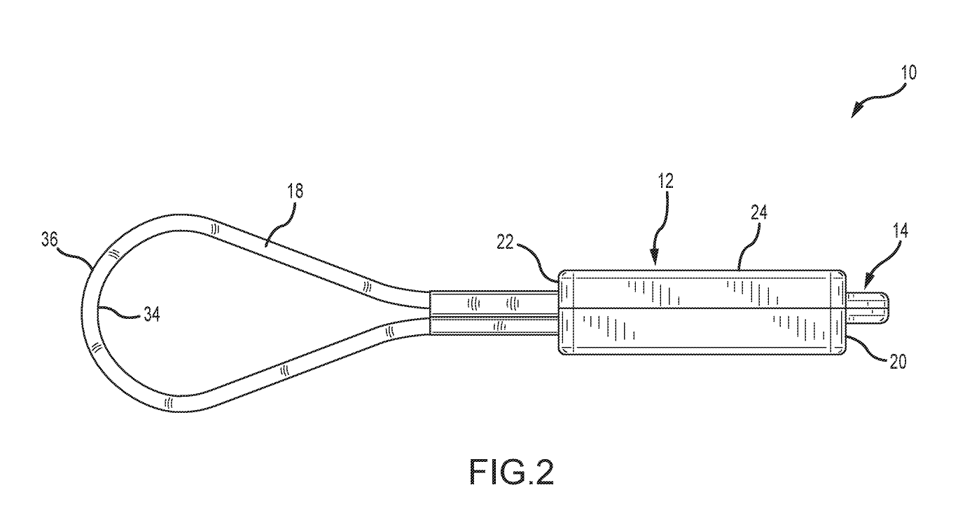

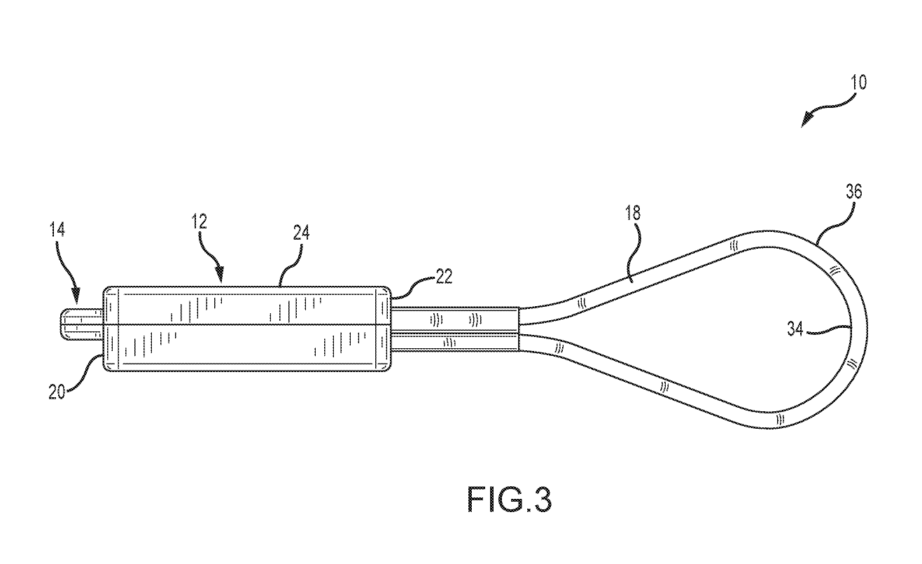

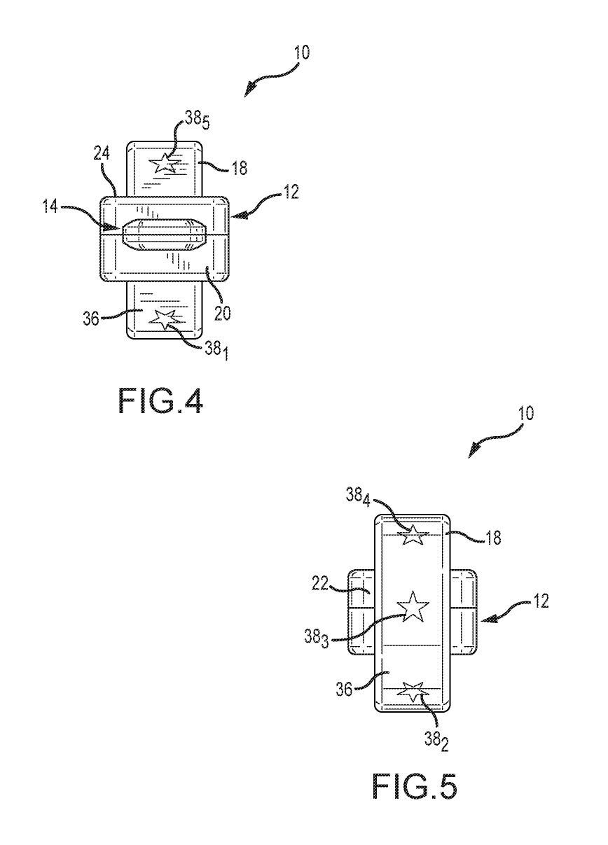

Referring to the figures, wherein like reference numerals refer to the same or similar features in the various views, FIGS. 1-7 illustrate various external features of an exemplary illuminable key chain 10 (which may be referred to in this disclosure simply as “the key chain 10” for ease of reference). The exemplary key chain 10 includes a housing 12, a receiving formation 14 disposed on the housing 12, a switch 16, and a band 18.

The exemplary housing 12 is a generally rectangular prism that includes a key side 20, a band side 22, and a top surface 24. The key side 20 is opposite the band side 22, in the exemplary housing 12. A depression 26 is provided in the top side of the exemplary housing 12, and the top side is generally perpendicular to the band side 22 and the key side 20. In the exemplary housing 12, the switch 16 is disposed in the depression 26.

The receiving formation 14 is provided in the exemplary key chain 10 to receive a key ring. The key ring may be, for example only, a circular spiral loop, a carabiner, or a similar device. Accordingly, the receiving formation 14 may be a projection provided on the housing 12, as illustrated in FIGS. 1-7, that defines a circular aperture through which the key ring may be inserted. Alternatively, the receiving formation 14 may be a projection defining an aperture of some other shape (e.g., a rectangle or triangle, for example) through which the key ring may be inserted.

Referring to FIGS. 1-8, the switch 16 is provided on or in the housing 12. As noted above, in the exemplary key chain 10, the switch 16 is provided in the depression 26. As a result, some or all of the height of the switch 16 is within the depression 26 and the outer surface of the switch 16 is slightly above the plane of the top surface 24 of the housing 12, in the exemplary key chain 10. In various examples, the outer surface of the switch 16 may be within the threshold of the plane of the top surface 24 of the housing 12, or substantially in the plane of the top surface 24 of the housing 12. As a result, a user is provided with a pleasing tactile access to the switch 16 while reducing the likelihood that the switch 16 may be accidentally actuated (e.g., while in a user's pocket).

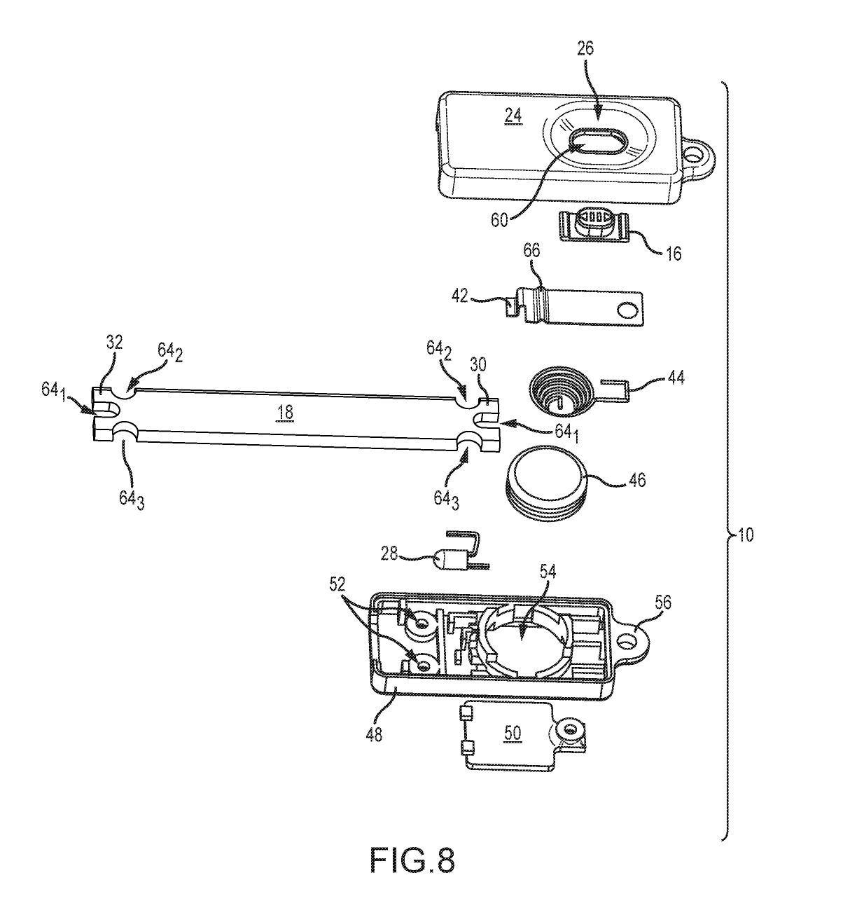

The switch 16 is configured to selectively activate and deactivate a light source 28, which is illustrated in and will be described below in detail with respect to FIG. 8. With continued reference to FIGS. 1-7, the exemplary switch 16 has three states. In a first state, illustrated in FIGS. 1-7, the switch 16 is in a first lateral position and first vertical position relative to the housing 12. The user may laterally slide the switch 16 to reach a second state, in which the switch 16 is in a second lateral position, while remaining in the first vertical position. In one example, once placed in the second state by a user, the switch 16 may remain in the second state until the user actuates the switch 16 back to the first state, and vice-versa. The switch 16 also has a third state, in which the switch 16 has a second vertical state, by pressing on the switch 16. The switch 16 may remain in the third state as long as held in the third state by a user (e.g., as long as the switch 16 is pressed inward), but may return to the first or second state automatically upon release by the user. Although the switch 16 has been and will be described with reference to an example switch 16 having three states, this disclosure is not so limited. In other examples, the switch 16 may have two states, or more than three states.

The first, second, and third states of the switch 16 may control the light source 28 in a variety of ways, in different examples. In one example, in the first state, the light source 28 is deactivated; in the second state, the light source 28 is activated, and in the third state, the light source 28 is activated. In such an example, the user may use the first state to activate the light source 28 for an extended period of time and the third state to activate the light source 28 for a brief period of time. In other examples, the first, second, and third states may control the light source 28 differently. For example, in the first state of the switch 16, the light source 28 may be deactivated; in the second state, the light source 28 may output light at a first frequency; and in the third state, the light source 28 may output light at a second frequency. Additionally or alternatively, the states of the switch 16 may be employed, in conjunction with appropriate electrical or electronic components, to modulate the frequency or brightness of the light source 28, to make the light source 28 flash periodically, or to control some other behavior of the light source 28.

Referring to FIGS. 1-8, the exemplary band 18 includes a first end 30, a second end 32, an inner surface 34, an outer surface 36, and a generally ribbon-like structure extending in length from the first end 30 to the second end 32. As shown in FIGS. 1-7, both ends 30, 32 of the band 18 may be coupled with or disposed in the housing 12. In the exemplary key chain 10, both ends 30, 32 of the band 18 are coupled with and enter the housing 12 through the same side (i.e., the band side 22 of the housing 12). Accordingly, the band 18 forms a closed loop in conjunction with the band side 22 of the housing 12, in the illustrated example. In the exemplary key chain 10, the band 18 is untwisted in forming the loop. In other embodiments, the band 18 may be twisted in forming the loop. Further, the exemplary band 18 has a uniform width over its length. In other examples, the band 18 may have a variable width over its length. Still further, the exemplary band 18 is straight—that is, not curved when laid out flat, as illustrated in FIG. 8. In other examples, the band 18 may be curved.

The band 18 may be made of a polymer. For example, the band 18 may be made of thermoplastic polyurethane (TPU) or another appropriate polymer. In other examples, the band 18 may be made of more than one material, and may be made of a material other than polymer. The band 18 may be formed from a transparent or translucent material. The band 18 may also be made of a light-conducting material. The band 18 may be made from a colored or colorless material. Accordingly, the band 18 may be made of a transparent, light-conducting, colorless material, in one example.

One or more symbols or words 38 are engraved, etched, incised, or otherwise impressed on the inner surface 34 of the exemplary band 18. Five symbols 38₁, 38₂, 38₃, 38₄, 38₅ are illustrated on the inner surface 34 of the exemplary band 18 in FIGS. 1-7, but are omitted from FIG. 8 for clarity of illustration. In another example, one or more symbols or words 38 may additionally or alternatively be impressed on an outer surface 36 of the band 18. The symbols or words 38 may be, for example only, logos, designs, names, slogans, and the like. In the illustrated embodiment, the symbols or words 38 are stars, but this disclosure is not limited to stars as the symbols or words 38. In other examples, the symbols or words 38 may be any set of one or more symbols and/or words 38.

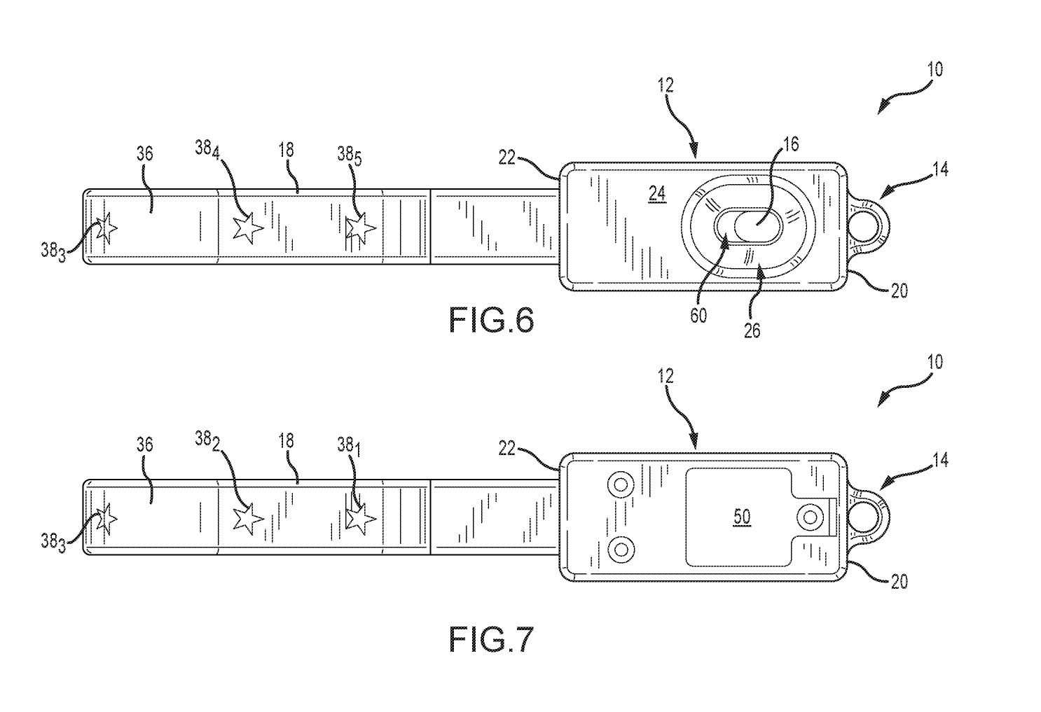

In the illustrated exemplary key chain 10, the symbols 38 on the inner surface 34 of the band 18 are visible through the band 18. Thus, in FIG. 1, three symbols 38₁, 38₂, 38₃ are directly visible and two symbols 38₄, 38₅ are visible through the band 18. In FIG. 6, two symbols 38₁, 38₂ provided on the opposite portion of the loop are omitted for clarity of illustration, though such symbols may be visible in some examples. Similarly, in FIG. 7, two symbols 38₄, 38₅ provided on the opposite portion of the loop are omitted for clarity of illustration, though such symbols 38₁, 38₂, 38₄, 38₅ may be visible from the same angles, in some examples.

Referring to FIG. 8, the interior components and further details of the functionality of the exemplary key chain 10 will be described. The exemplary key chain 10 includes an upper housing portion 40, the switch 16, an electrical contact plate 42, an electrical connection wire 44, the band 18, a battery 46, a light source 28, a lower housing portion 48, and a back plate 50.

The housing portions 40, 48 may be made from plastic, in an example, using one or more of the following example techniques: injection molding, extrusion molding, vacuum forming, and/or compression molding. The housing portions 40, 48 may be formed from the same material through the same technique, or may be formed from different materials through different techniques. One or more fasteners (not shown), such as screws, may be used to couple the back plate 50 to the lower housing portion 48 and the lower housing portion 48 to the upper housing portion 40 with the electrical contact plate 42, electrical connection wire 44, band 18, battery 46, and light source 28 wholly or partially contained within the assembled housing 12.

The lower housing portion 48 may define three fastener apertures 52 (one of which is obscured in FIG. 8), a central cavity 54, and a lower portion 56 of the receiving formation 14. The cavity 54 may be configured in size and shape to receive and retain the battery 46 and electrical connection wire 44. Accordingly, the battery 46 and electrical connection wire 44 are disposed within the exemplary housing 12 and configured to be selectively electrically coupled with the light source 28 responsive to actuation of the switch 16.

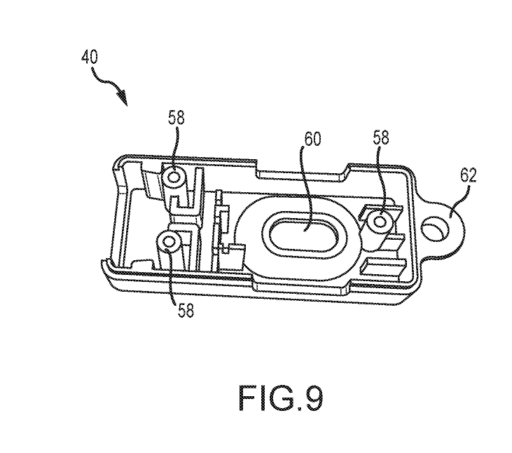

Referring to FIG. 9, the upper housing portion 40 may include posts 58 that align with respective ones of the fastener apertures 52 of the lower housing portion 48. Fasteners may be inserted through the fastener apertures 52 and into the posts 58 to couple the housing portions 40, 48 together. Alternatively, the housing portions 40, 48 may be coupled together through press-fit, with adhesive, or some other coupling mechanism. The upper housing portion 40 may further define a switch aperture 60 and an upper portion 62 of the receiving formation 14. The switch aperture 60 is defined within the depression 26, in the exemplary upper portion 40 of the housing 12. The switch 16 extends out through the switch aperture 60, as illustrated in FIGS. 1 and 6.

The illustrated housing 12 is exemplary in nature only. In other examples, the housing 12 may have a different shape, such as a generally rectilinear shape having more than six sides, a round shape, or some other shape. Furthermore, the housing 12 may be made from more than two pieces, in other examples, and/or from pieces having a different arrangement from that illustrated and explicitly described in this disclosure.

Referring to FIGS. 8 and 9, the band first end 30 and second end 32 may each have respective indentations 64 configured in size and shape to secure the ends of the band 18 within the housing 12. For example, as illustrated in FIG. 8, each end of the band 18 may have a light source indentation 64₁ and two post indentations 64₂, 64₃. The post indentations 64₂, 64₃, shown in FIG. 8, may be configured in size and shape to fit over and around the posts 58 of the upper housing portion 40, shown in FIG. 9. The light source indentation 64₁ may be configured in size and shape to fit around the light source 28. Accordingly, when assembled, the light source 28 may be held within the light source indentations 64₁ of the two ends of the band 18, which in turn may be held by the posts 58 of the upper housing portion 40. Further, when the key chain 10 is assembled, a first portion of the polymer band 18 (where the first portion comprises the two ends 30, 32) is disposed within the housing 12 and a second portion of the band 18 projects outward from the housing 12.

The band 18 is not limited to the exact construction shown. In other examples, the band 18 may include protrusions in addition to or instead of indentations 64 for coupling with one or more aspects of the housing 12. In addition, in an example, the band 18 may be rigidly coupled with an insert wedge, which insert wedge may be configured to be non-removably inserted into the housing 12 in the assembly process, or other coupling mechanism or element.

The light source 28 is configured in size and shape to be received and secured within the housing 12 and to project light when supplied with power. The light source 28 may include one or more light-emitting diodes (LEDs), in one example. Additionally or alternatively, the light source 28 may include a laser, incandescent bulb, fluorescent bulb, high-intensity discharge bulb, or other appropriate source of light. The light source 28 may provide light at any appropriate frequency and brightness. In addition, the frequency and brightness of the light source 28 may be static, or may be adjustable. For example, the key chain 10 may be provided with electronics to modulate the frequency or brightness of the light source 28, make the light source 28 flash, etc. responsive to actuation of the switch 16.

Due to the positioning and orientation of the light source 28 in the assembled exemplary key chain 10, the light source 28 projects light directly into the band 18 through the ends 30, 32 of the band 18. The band 18 may conduct that light to illuminate the band 18 and to illuminate and highlight any symbols or words 38 impressed on the band 18. As a result, the symbols or words 38 may be lit from within the band 18. In other examples, the light source 28 may be positioned differently relative to the band 18, such that the symbols or words 38 may be lit from the exterior of the band 18. For example, the housing 12 may include a slot or aperture to direct light from the light source 28 into the loop formed by the band 18, or the light source 28 may otherwise be positioned to project light directly onto the surface of the band 18 on which the symbols or words 38 are impressed.

In the illustrated example, the light source 28 is sealed within the housing 12. That is, in the illustrated example, no part of the light source 28 itself lies outside of the housing 12, and no access to the light source 28 is available from outside the housing 12. Light produced by the light source 28 may escape from the housing 12 (e.g., as conducted by the band 18, by escaping through cracks and seams in and between elements of the key chain 10, or by shining through the material of the housing 12 itself, for example), but the light source 28 itself may be wholly contained and sealed within the housing 12, as in the exemplary illustrated key chain 10.

With continued reference to FIG. 8, the electrical contact plate 42 and electrical connection wire 44 are disposed within the housing 12 and provided to selectively couple the light source 28 with the battery 46 responsive to actuation of the switch 16. For example, with the switch 16 in the first state, an open circuit may exist between the light source 28 and the battery 46. With the switch 16 in the second state (i.e., slid forward), a protrusion 66 on the electrical contact plate 42 may be forced downward by the switch 16 to close a circuit formed by the battery 46, electrical connection wire 44, electrical contact plate 42, and light source 28, and provide electrical current from the battery 46 to the light source 28 to activate the light source 28. In the third state (i.e., pressed downward), the switch 16 may force the entire electrical contact plate 42 downward to the same effect. In the illustrated example, the electrical connection wire 44 is coiled into a spring that provides a return force to the switch 16. As a result, when the user releases the switch 16 while in the third state, the spring returns the switch 16 to its previous state.

In operation, the light source 28 may be selectively activated and deactivated by a user through use of the switch 16. When activated, the light source 28 may project light into the band 18. The band 18 may conduct the light so as to illuminate itself and to illuminate/highlight any symbols and/or words 38 impressed on the band 18.

Although certain embodiments of the present invention have been described herein, it is not intended that the disclosure be limited merely to those embodiments. The foregoing description and drawings are merely to explain and illustrate the invention and the invention is not limited thereto except insofar as the appended claims are so limited, as those skilled in the art who have the disclosure before them will be able to make modifications and variations therein without departing from the scope of the invention.

1. An illuminable key chain comprising:
a housing;
a receiving formation on the housing configured to receive a key ring;
a solid band having a first end and a second end, the first and second ends coupled to the housing, at least one of the first end and the second end defining a light source indentation; and
a light source disposed within the housing and within the light source indentation of the band and configured to project light into or onto the band when the light source is supplied with power.

2. The illuminable key chain of claim 1, wherein the housing comprises a first side, wherein the first end and the second end of the band enter the housing through the first side of the housing.

3. The illuminable key chain of claim 2, wherein the housing comprises a second side opposite the first side, wherein the receiving formation is on the second side of the housing.

4. The illuminable key chain of claim 1, further comprising a switch disposed on or in the housing and configured to be actuated by a user to selectively activate and deactivate the light source.

5. The illuminable key chain of claim 4, wherein the switch comprises a first state in which the switch is in a first position and the light source is activated and a second state in which the switch is in a second position and the light source is deactivated.

6. The illuminable key chain of claim 5, wherein the switch is configured to remain in the first state or the second state after being placed in the first state or the second state until further actuation by a user, and the switch further comprises a third state in which the light source is activated, the switch is in a third position, and the switch is configured to return from the third state to the second state automatically.

7. The illuminable key chain of claim 4, further comprising a battery disposed within the housing and configured to be selectively electrically coupled with the light source responsive to actuation of the switch.

8. The illuminable key chain of claim 1, further comprising one or more symbols or words engraved, etched, or incised on a surface of the band.

9. The illuminable key chain of claim 8, wherein the one or more symbols or words are engraved, etched, or incised on an inner surface of a loop formed by the band.

10. The illuminable key chain of claim 1, wherein the band comprises thermoplastic polyurethane.

11. An illuminable key chain, comprising:
a housing;
a receiving formation on the housing configured to receive a key ring;
a solid polymer band, a first portion of the polymer band disposed within the housing and defining a light source indentation, a second portion of the polymer band projecting outward from the housing, the polymer band configured to conduct light; and
a light source disposed within the housing and within the light source indentation of the band and configured to project light into the first portion of the polymer band when the light source is provided with power.

12. The illuminable key chain of claim 11, wherein the polymer band comprises a first end and a second end, at least one of the first end and second end including one or more protrusions or indentations for coupling with one or more complementary formations in the housing.

13. The illuminable key chain of claim 12, wherein the first end and second end of the polymer band are coupled with a first side of the housing.

14. The illuminable key chain of claim 13, wherein the receiving formation is provided on a second side of the housing that is opposite the first side.

15. The illuminable key chain of claim 11, wherein the receiving formation comprises a loop projecting off of the housing.

16. The illuminable key chain of claim 11, further comprising one or more symbols or words engraved, etched, or incised on a surface of the band.

17. The illuminable key chain of claim 16, wherein the one or more symbols or words are engraved, etched, or incised on an inner surface of a loop formed by the band.

18. The illuminable key chain of claim 17, wherein the band comprises thermoplastic polyurethane.

19. The illuminable key chain of claim 11, further comprising a switch disposed on or in the housing and configured to be actuated by a user to selectively activate and deactivate the light source.

20. The illuminable key chain of claim 11, wherein the housing comprises a depression on an outer surface of the housing, the switch disposed in the depression.
